(19) United States
(12) Patent Application Publication
(10) Pub. No.: US 2019/0341211 A1
(43) Pub. Date: Nov. 7, 2019

(54) CONTACT SURFACE FOR MEMS DEVICE

(71) Applicant: Innovative Micro Technology, Goleta, CA (US)

(72) Inventor: Christopher S. GUDEMAN, Lompoc, CA (US)

(73) Assignee: Innovative Micro Technology, Goleta, CA (US)

(21) Appl. No.: 16/515,678

(22) Filed: Jul. 18, 2019

Related U.S. Application Data
(62) Division of application No. 15/698,819, filed on Sep. 8, 2017.
(60) Provisional application No. 62/393,182, filed on Sep. 12, 2016.

(51) Int. Cl. H01H 59/00; H01H 49/00

(52) U.S. Cl. CPC H01H 59/0009; H01H 2001/0052; H01H 2229/016; H01H 49/00

(57) ABSTRACT

Systems and methods for forming an electrostatic MEMS switch that is used to hot switch a source of current or voltage. At least one surface of the MEMS switch is treated with an ion milling machine to reduce surface roughness to less than about 10 nm rms.

### CROSS REFERENCE TO RELATED APPLICATIONS

This non-Provisional US patent application is a divisional application, claiming priority to U.S. patent application Ser. No. 15/698,819 filed Sep. 8, 2017, which in turn is a US non-provisional application claiming priority to U.S. Provisional Patent Application Ser. No. 62/393,182, filed Sep. 12, 2016. Each of these prior applications is incorporated by reference in their entireties.

### STATEMENT REGARDING FEDERALLY SPONSORED RESEARCH

Not applicable.

### STATEMENT REGARDING MICROFICHE APPENDIX

Not applicable.

### BACKGROUND

This invention relates to a microelectromechanical systems (MEMS) switch device, and its method of manufacture. More particularly, this invention relates to a MEMS hot switch, which closes two electrodes while a voltage is applied.

Microelectromechanical systems are devices often having moveable components which are manufactured using lithographic fabrication processes developed for producing semiconductor electronic devices. Because the manufacturing processes are lithographic, MEMS devices may be made in very small sizes, and in large quantities. MEMS techniques have been used to manufacture a wide variety of sensors and actuators, such as accelerometers and electrostatic cantilevers.

MEMS techniques have also been used to manufacture electrical relays or switches of small size, generally using an electrostatic actuation means to activate the switch. MEMS devices often make use of silicon-on-insulator (SOI) wafers, which are a relatively thick silicon “handle” wafer with a thin silicon dioxide insulating layer, followed by a relatively thin silicon “device” layer. In the MEMS devices, a thin cantilevered beam of silicon may be etched into the silicon device layer, and a cavity is created adjacent to the thin beam, typically by etching the thin silicon dioxide layer below it to allow for the electrostatic deflection of the beam. Electrodes provided above or below the beam may provide the voltage potential which produces the attractive (or repulsive) force to the cantilevered beam, causing it to deflect within the cavity.

One known embodiment of such an electrostatic relay is disclosed in U.S. Pat. No. 6,486,425 to Seki. The electrostatic relay described in this patent includes a fixed substrate having a fixed terminal on its upper surface and a moveable substrate having a moveable terminal on its lower surface. Upon applying a voltage between the moveable electrode and the fixed electrode, the moveable substrate is attracted to the fixed substrate such that an electrode provided on the moveable substrate contacts another electrode provided on the fixed substrate to close the microrelay.

MEMS switches may fail if modest voltage is present across the open contacts when the switch is closed or opened. This is referred to as “Hot Switching”. This occurs because the contacts of a switch are microscopically rough. The true area of solid-solid interaction between the contacts is thus limited to that area at the tip of the tallest asperities. This true area of contact is typically much less than 1 um². If voltage is present on the contacts during this brief time interval when the contact area is vanishingly small, immense heating of the asperity peaks that carry the instantaneous current spike can occur. This often exceeds the melting point of the contact materials.

Previous attempts to improve reliability include chemical mechanical polishing of materials. This will often contaminate the surface, which must remain atomically clean in order to provide low contact resistance. Roughness can also be reduced by tediously reducing the roughness of each of the layers in a tin film stack, such as the oxide/Ti/TiW/Au/Ru/RuO2 stack that is typically used in MEMS switches. Because these stacks are complex and multilayered, this is a time consuming and ad hoc process. A more general and effective method is needed.

### SUMMARY

We describe a method that uses an ion mill to atomically polish the surface. This also provides a means of atomically cleaning the surface, which also improves the quality of the contacting interface. The only material that contacts the surfaces is the Ar+ or Kr+ ions in the ion beam. Because these ions travel at high velocity, they are able to etch off the peaks of the asperities, thus reducing the roughness and cleaning the surface of contaminants and/or debris.

Disclosed here is a MEMS device with at least one contact surface having a surface roughness of less than about 10 nm rms, and the contact surface allows electrical access to the MEMS device. The surface may be formed by treating the contact surface by applying an ion mill against the surface, and imparting a less than 10 nm rms surface roughness to the surface using the ion mill against the surface

More specifically, a MEMS device is described, which may have at least one first contact surface, wherein the at least one first contact surface has a surface roughness of less than about 10 nm rms, and at least one additional contact surface, wherein the first and the additional contact surface are configured to be in physical and electrical contact during at least a portion of the MEMS device operation.

A method for forming the MEMS device is also described, and may include treating the at least one contact surface in the MEMS device by directing ions from an ion mill against the surface, and imparting a less than 10 nm rms surface roughness to the surface using the ions from the ion mill against the surface.

These and other features and advantages are described in, or are apparent from, the following detailed description.

### BRIEF DESCRIPTION OF THE DRAWINGS

Various exemplary details are described with reference to the accompanying drawings, which, however, should not be taken to limit the invention to the specific embodiments shown but are for explanation and understanding only.

FIG. 1 is an illustrative view of an exemplary embodiment of a surface treatment for a MEMS contact surface using ion milling.

FIG. 2 is a cross sectional view of an exemplary dual substrate electrostatic MEMS switch using the treated contact surface;

FIG. 3 is a view of an exemplary embodiment for surface treatment for a MEMS contact surface for a plate substrate using ion milling; and

FIG. 4 is a view of an exemplary embodiment for a surface treatment for a MEMS contact surface for a via substrate using ion milling.

It should be understood that the drawings are not necessarily to scale, and that like numbers maybe may refer to like features.

### DETAILED DESCRIPTION

A method is described below that uses an ion mill to atomically polish the surface. This also provides a means of atomically cleaning the surface, thereby improving the quality of the contacting interface. The only material that contacts the surfaces is the Ar+ or Kr+ ions in the ion beam. Because these ions travel at high velocity, they are able to etch off the peaks of the asperities, thus reducing the roughness. As a result, surface phenomena such as contact resistance, friction and stiction or contact welding may be better characterized and repeatable, and switch performance may be anticipated with greater confidence. This may be important in optimizing yields and process flow in a MEMS manufacturing environment.

The MEMS device may have at least one contact surface, wherein the at least one contact surface has a surface roughness of less than about 10 nm rms, and the contact surface provides electrical communication with the MEMS device. The surface may be formed by treating the contact surface by using an ion mill against the surface; and imparting a less than 10 nm rms surface roughness to the surface using the ion mill against the surface. The contact surface may had a roughness lower limit of about 1 nm.

Furthermore, the MEMS device may have at least one additional contact surface, wherein the first and the additional contact surface are configured to be in physical and electrical contact during at least a portion of the MEMS device operation. As used herein, the acronym “rms” refers to “root mean square,” which is understood by one of ordinary skill in the art to refer to the arithmetic mean of the squares of a set of numbers, and is a term routinely used to characterize surface roughnesses.

For example, in the case of an electrostatic MEMS switch, two electrical contacts may be formed on a pair of electrostatic plates. The contact surfaces may be been treated according to the ion milling technique described herein. The plates may be held apart in general by a number of restoring springs. To activate the MEMS switch, a voltage may be applied between two electrostatic plates, causing the plates to be drawn together until the contact surfaces touch. When the contact surfaces touch, a current may flow between the contacts. However, because of the surface preparation of the two contact surfaces, there is sufficient area of contact that the contact materials are not heated excessively and thus are not melted or damaged. Excessive heating and melting are the predominant cause of stiction. Additionally, the contact surfaces may not be polished so smoothly that stiction becomes an issue, but instead, the stiction forces may fall within an anticipated range because of the repeatability and predictability of the surface roughness treatment.

Indeed, the microscopic peak temperature at the point of contact can be estimated if the voltage drop across the contacts can be measured. The formula below provides this relationship using the Wiedemann-Franz law (see, for example, https://en.wikipedia.org/wiki/Wiedemann%E2%80%93Franz_law):

$${T}_{C} = \sqrt{\frac{{V}^{2}}{4 L} + {T}_{o}^{2}} ,$$

where L is the Lorentz constant=2.45×10⁻⁸ W-Ohm/K². This predicts that for even a modest voltage drop (0.5V) across the contacts, the peak temperature (T_{C}) above the ambient (Tₒ) is 1600 K, where most materials melt. This high temperature is confined both in location (the tips of the contacting asperities) and in time, which can be estimated given the RMS roughness (Rs˜10 nm) and the impact velocity (100 mm/sec) of the contacts during closure:

t(contact)˜1e−8 m/0.1 m/sec=1 nsec.

Melting of the contacts can thus be reduced or eliminated by decreasing the roughness or increasing the velocity. Increasing the velocity can lead to peening damage of the contacts. Reducing the roughness using conventional polishing methods is very difficult for the micro-contacts typically used in MEMS switches. Ion milling, applied to the surface at a grazing or acute incidence angle, may be a process step that can be applied to these small surfaces, in order to render a surface with a repeatable, predictable and well defined surface roughness. Ion milling at normal incidence, where no shadowing occurs, also reduces the roughness, which can be understood as follows. When an incident high energy Ar+ of Kr+ ion impacts a surface, it penetrates 2-5 atomic layers in depth. Thus the volume of surface atoms is placed momentarily in an excited state, which them relaxes to a lower level by expelling the most weakly bound atom or atoms in the excited ensemble. It is the atom at the very tip of an asperity that is generally the most weakly bound. Ejection of this atom consequently reduces roughness.

Ion milling is a physical etching technique whereby the ions of an inert gas (typically Ar⁺ or Kr⁺) are accelerated by a differential voltage from a wide beam ion source into the surface of a substrate (or coated substrate) in a vacuum in order to remove material to some desired depth or underlayer.

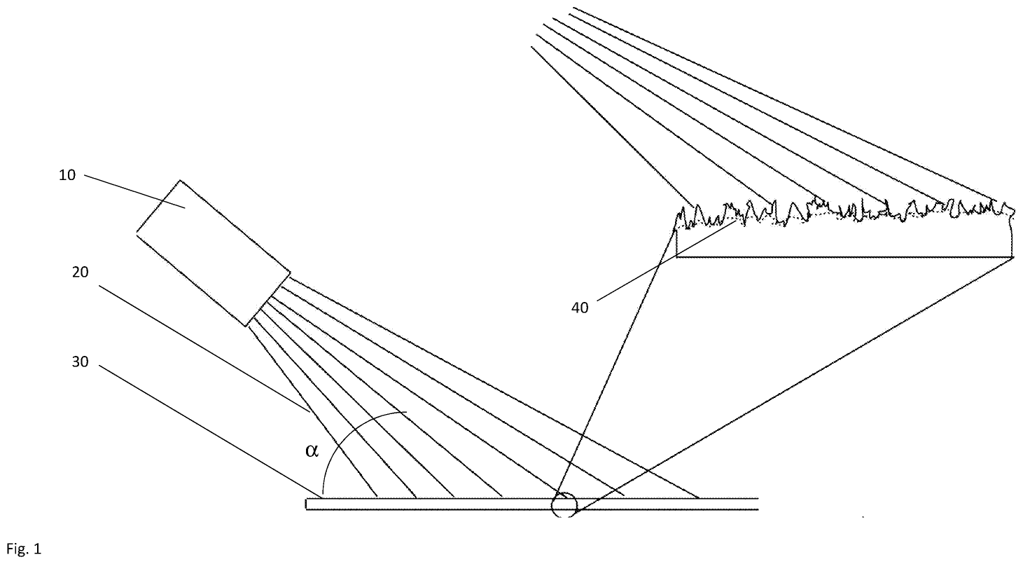

An ion beam is often used to etch surfaces to form microstructures, such as MEMS devices. If this ion beam impinges on the contacting surfaces at a grazing angle, the peaks of the asperities are preferentially etched, since the valleys lie in the shadows of the peaks. Even at normal incidence, some reduction in roughness can be expected due to ion focusing onto the peaks due to the high fields that exist on these sharp points. An angle of between about 20 and 70 degrees may be suitable, and more specifically at about 50 degrees may be suitable. The grazing incidence angle α may be defined as the angle between the axis of the ion mill beam and the contact surface, as illustrated in FIG. 1. The grazing incidence angle may be an acute angle as previously defined, and may be between about 20 degrees and about 70 degrees. In another embodiment, the ion mill may be directed at normal incidence (90 degrees) to the surface.

Referring to FIG. 1, 10 is the ion source, and 30 is the surface being treated. Ions 20 are released from the source 10 and accelerated toward the surface 30 by a differential voltage. The ions may be drawn preferentially to the peak asperities on the surface 30 because of the concentration of field lines around the asperities. When the ions impinge upon the surface 30, they remove material from the surface which may be ejected from the surface and evacuated from the system. Alternatively, as described above, the technique may be used at normal incidence to the surface. This results in a removal of asperities, and so a smoothing of the surface. Root-mean-square surface roughnesses of less than about 10 nm may result from this treatment. The effect is illustrated in FIG. 1, wherein the insert shows the magnified surface roughness 40 of surface 30. The dotted line in FIG. 1 represents the smoothed contour of the surface 40, and indicates an rms roughness of less than about 10 nm. The contact surface may had a roughness lower limit of about 1 nm.

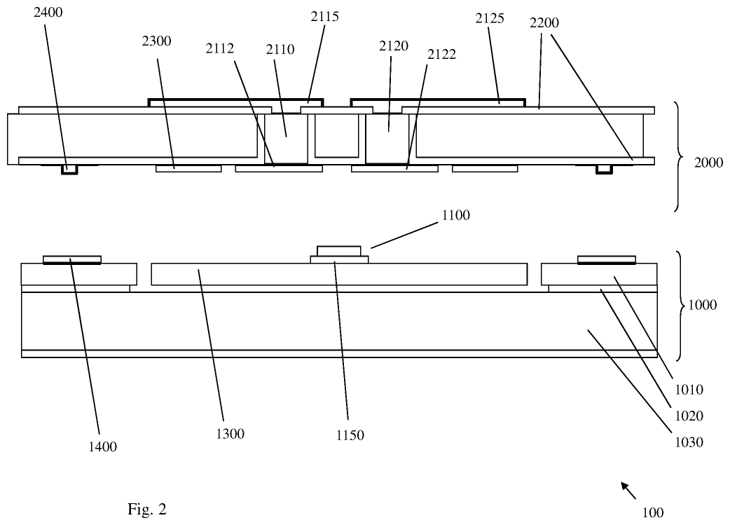

FIGS. 2-4 show an exemplary application for the contact surface treatment described here. MEMS switch 100 may be an electrostatically actuated MEMS electrical switch, wherein two electrical pads are shorted by a shunt bar when a voltage is applied between two electrostatic plates. The switch 100 is shown in cross section in FIG. 2.

This switch 100 may be fabricated on two substrates, a plate substrate 1000 and a via substrate 2000. The plate substrate 1000 may be an SOI wafer, and the via substrate may be a silicon wafer, for example. The SOI plate substrate 1000 may include a silicon device layer 1010, an insulating layer 1020, and a thicker, silicon handle layer 1030. SOI wafers are well known in the art.

The switch 100 may include a plate 1300 bearing at least one shunt bar 1100. The shunt bar 1100 may include an insulating pad 1150 and an electrical contact surface 1160. The plate 1300 may be deformable, meaning that it is sufficiently thin compared to its length or its width to be deflected when a force is applied, and may vibrate in response to an impact. For example, a deformable plate may deflect by at least about 10 nm at its center by a force of about 1 uNewton applied at the center, and sufficiently elastic to support vibration in a plurality of vibrational modes.

The deformable plate 1300 may be suspended above the handle layer 1030 of an SOI plate substrate 1000 by two to eight spring beams (not shown in FIG. 2), which are themselves affixed to the silicon handle layer 1030 by anchor points formed from the insulating dielectric layer 1020 of the SOI plate substrate 1000. As used herein, the term “spring beam” should be understood to mean a beam of flexible material affixed to a substrate at a proximal end, and formed in substantially one plane, but configured to move and provide a restoring force in a direction substantially perpendicular to that plane. The deformable plate 1300 may carry at least one conductive shunt bar 1100 which operates to close the switch 100, as described below.

Additional details of such a device are disclosed in U.S. Pat. No. 7,893,798 B2, (Attorney Docket No. IMT-V3) issued Feb. 22, 2011 and assigned to the same assignee. This patent is incorporated by reference in its entirety.

The deformable plate 1300 may be actuated electrostatically by an adjacent electrostatic electrode 2300, which may be disposed directly above (or below) the deformable plate 1300, and may be fabricated on the via substrate 2000. The deformable plate 1300 itself may form one plate of a parallel plate capacitor, with the electrostatic electrode 2300 forming the other plate. When a differential voltage is placed on the deformable plate 1300 relative to the adjacent electrostatic electrode 2300, the deformable plate is drawn toward the adjacent electrostatic electrode 2300. The action raises (or lowers) the shunt bar 1100 until it spans the contact points 2112 and 2122, thereby closing an electrical circuit.

Although the embodiment illustrated in FIG. 2 shows the plate formed on the lower substrate and the vias and contacts formed on the upper substrate, it should be understood that the designation “upper” and “lower” is arbitrary. The deformable plate 1300 may be formed on either the upper substrate 2000 or lower substrate 1000, and the vias and contacts formed on the other substrate. However, for the purposes of the description which follows, the embodiment shown in FIG. 2 is presented as an example, wherein the deformable plate 1300 is formed on the lower substrate 1000 and is pulled upward by the adjacent electrode 2300 formed on the upper substrate 2000.

The MEMS electrostatic switch device 100 with a contact surface treatment may be fabricated as follows. Beginning with the plate substrate 1000, an insulating layer of dielectric material 1020, such as SiO₂ may be grown or deposited on the silicon surfaces. Alternatively, the SiO₂ layer may exist as the insulating layer 1020 on a silicon-on-insulator (SOI) substrate 1000. The dielectric layer 1020 may then be etched away beneath and around the deformable plate 1300, using a hydrofluoric acid liquid etchant, for example. The liquid etch may remove the silicon dioxide dielectric layer 1020 in all areas where the deformable plate 1300 is to be formed. The liquid etch may be timed, to avoid etching areas that are required to affix the spring beams of the deformable plate 1300, which will be formed later, to the handle layer 1030. Additional details as to the dry and liquid etching procedure used in this method may be found in U.S. patent application Ser. No. 11/359,558, now U.S. Pat. No. 7,785,913 (Attorney Docket No. IMT-SOI Release), filed Feb. 23, 2006 and incorporated by reference in its entirety.

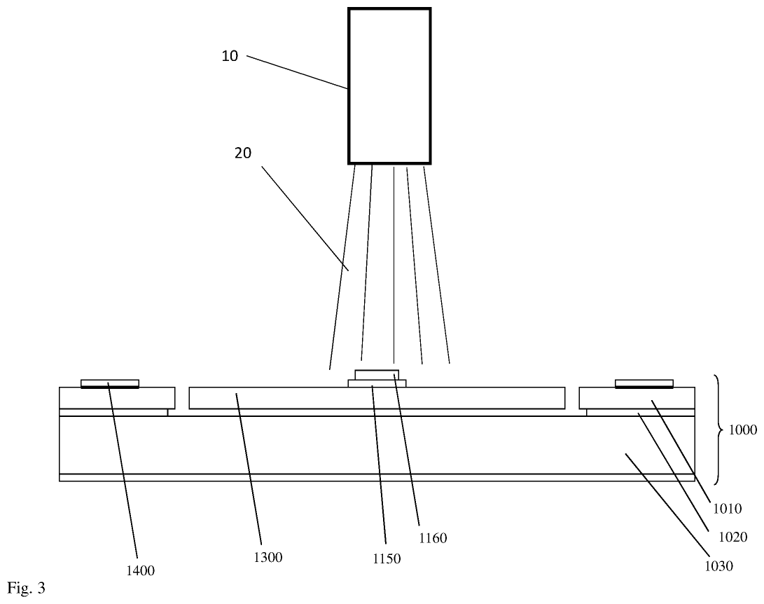

The next step in the exemplary method is the formation of the dielectric pad 1150 as depicted in FIG. 3. Pad structures 1150 forms an electrical isolation barrier between the shunt bar 1100 and the deformable plate 1300, and other standoffs may form a dielectric barrier preventing the corners of the deformable plate 1300 from touching the adjacent actuation electrode 2300. The deformable plate 1300 and adjacent actuation electrode 2300 form the two plates of a parallel plate capacitor, such that a force exists between the plates when a differential voltage is applied to them, drawing the deformable plate 1300 towards the adjacent actuation electrode 2300.

The dielectric structure 1150 may be silicon dioxide, which may be sputter-deposited over the surface of the device layer 1010 of the SOI plate substrate 1000. The silicon dioxide layer may be deposited to a depth of, for example, about 300 nm. The 300 nm layer of silicon dioxide may then be covered with photoresist which is then patterned. The silicon dioxide layer is then etched to form structure 1150. The photoresist is then removed from the surface of the device layer 1010 of the SOI plate substrate 1000. Because the photoresist patterning techniques are well known in the art, they are not explicitly depicted or described in further detail.

In the next step, a conductive material is deposited and patterned to form the shunt bar 1100 and a portion of what may form the hermetic seal. The hermetic seal may include a metal alloy formed from melting a first metal into a second metal, and forming an alloy of the two metals which blocks the transmission of gases. In preparation of forming the hermetic seal, a perimeter of the first metal material 1400 may be formed around the deformable plate 1300. The conductive material may actually be a multilayer comprising first a thin layer of chromium (Cr) for adhesion to the silicon and/or silicon dioxide surfaces. The Cr layer may be from about 5 nm to about 20 nm in thickness. The Cr layer may be followed by a thicker layer about 300 nm to about 700 nm of gold (Au), as the conductive metallization layer. Preferably, the Cr layer is about 15 nm thick, and the gold layer is about 600 nm thick. Another thin layer of molybdenum may also be used between the chromium and the gold to prevent diffusion of the chromium into the gold, which might otherwise raise the resistivity of the gold.

Each of the Cr and Au layers may be sputter-deposited using, for example, an ion beam deposition chamber (IBD). The conductive material may be deposited in the region corresponding to the shunt bar 1100, and also the regions which will correspond to the bond line 1400 between the plate substrate 1000 and the via substrate 2000 of the dual substrate electrostatic MEMS plate switch 100. This bond line area 1400 of metallization will form, along with a layer of indium, a seal which will hermetically seal the plate substrate 1000 with the via substrate 2000, as will be described further below.

While a Cr/Au multilayer is disclosed as being usable for the metallization layer of the shunt bar 1100, it should be understood that this multilayer is exemplary only, and that any other choice of conductive materials or multilayers having suitable electronic transport properties may be used in place of the Cr/Au multilayer disclosed here. For example, other materials, such as titanium (Ti) may be used as an adhesion layer between the Si and the Au. Other exotic materials, such as ruthenium (Ru) or palladium (Pd) can be deposited on top of the Au to improve the switch contact properties, etc. However, the choice described above may be advantageous in that it can also participate in the sealing of the device through the alloy bond, as will be described more fully below.

To form the deformable plate 1300, the surface of the device layer 1010 of the SOI plate substrate 1000 is covered with photoresist which is patterned with the design of the deformable plate. The deformable plate outline is the etched into the surface of the device layer by, for example, deep reactive ion etching (DRIE). Since the underlying dielectric layer 1020 has already been etched away, there are no stiction issues arising from the liquid etchant, and the deformable plate is free to move upon its formation by DRIE. As before, since the photoresist deposition and patterning techniques are well known, they are not further described here.

The final step in the manufacturing process for the plate substrate 1000 may be the treatment of the electrical contact pad surface (shunt bar 1100) by exposing the surface to the ion mill as described above. The process is depicted in FIGS. 1 and 3. The wafer 1000 may be placed into the evacuated ion milling chamber at some angle relative to the source 10 of the ions. In one embodiment, the angle between the ion mill source 10 and the substrate 1000 may be about 20-70 degrees, or more particularly about 50 degrees. The ions 20 may be accelerated into the substrate 1000, thereby smoothing asperities.

Turning now to the via substrate 2000, another metallization region may be deposited over the substrate 2000, as shown in FIG. 2. This metallization layer may form the bond ring 2400 as well as adjacent electrostatic electrode 2300. The metallization region may define the second plate 2300 of the parallel plate capacitor of the switch. In one exemplary embodiment, the metallization layer may actually be a multilayer of Cr/Au, the same multilayer as was used for the metallization layer 1400 on the plate substrate 1000 of the dual substrate electrostatic MEMS plate switch 100. The metallization multilayer may have similar thicknesses and may be deposited using a similar process as that used to deposit metallization layer 1400 on substrate 1000. The metallization layer may also serve as a seed layer for the deposition of a metal solder bonding material, as described in the incorporated '798 patent. Insulating layer 2200 may be a native insulating layer of SiO₂ that forms around the silicon substrate 2000. Two more external (to the switch) electrical pads 2115 and 2125 may be connected to through substrate vias 2110 and 2120 (TSV) may provide electrical access to the two electrical contacts 2112 and 2122 within the device 100.

For the metallization of electrical contacts 2112 and 2122, the same multilayer structure may be used as described above, i.e. a Cr/Au multilayer. Each of the Cr and Au layers may be sputter-deposited using, for example, an ion beam deposition chamber (IBD). The conductive material may be deposited in the region corresponding to the contacts 2112 and 2122 as well as the metal bondline structure 2400, to form the via substrate 2000 of the dual substrate electrostatic MEMS plate switch 100. This bond line area 2400 of metallization will form, along with opposing layers 1400 on the plate substrate 1000, a seal which will hermetically seal the plate substrate 1000 with the via substrate 2000.

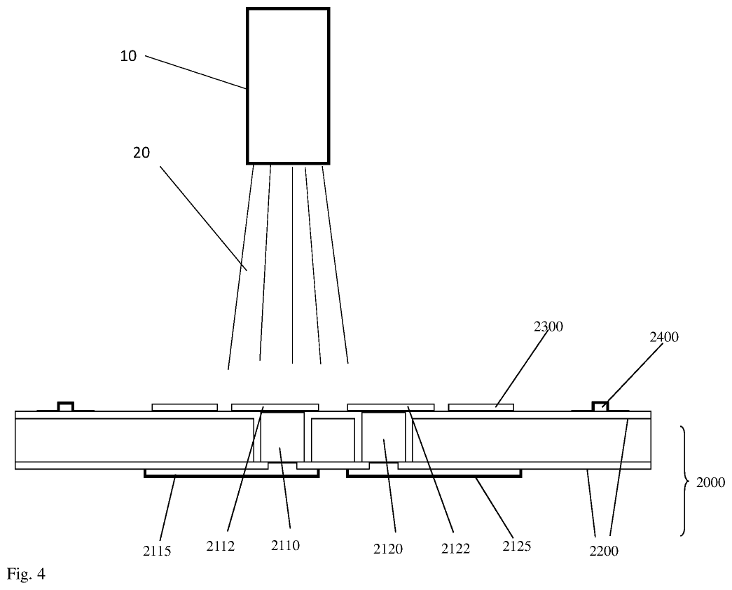

The final step in the manufacturing process for the via substrate 2000 may be the treatment of the contact surfaces 2112 and 2122 by exposing the surfaces to the ion mill as described above. The process is depicted in FIG. 4. The wafer 2000 may be placed into the evacuated ion milling chamber at some angle relative to the source 10 of the ions. In one embodiment, the angle between the ion mill source 10 and the substrate 2000 may be about 20-70 degrees, or more specifically about 50 degrees. The ions 20 may be accelerated into the substrate 2000, thereby smoothing asperities. In a second embodiment the incidence of ions is normal to the surface.

Finally, to form the switch, SOI plate substrate 1000 is pressed against the via substrate 2000 using bond lines 1400 and 2400, and the substrates are bonded together in a wafer bonding chamber for example. The adhesive may be a thermocompression bond, a metal alloy bond, or a glass frit bond for example. At bonding, the substrate-to-substrate separation is determined by a standoff 2400 in the bondline, as was shown in the FIG. 2

The deformable plate 1300 on substrate 1000 and adjacent actuation electrode 2300 on substrate 2000 may form the two plates of a parallel plate capacitor, such that a force exists between the plates when a differential voltage is applied to them, drawing the deformable plate 1300 towards the adjacent actuation electrode 2300.

A differential voltage may be applied to the deformable plate 1300 and the second plate through another set of TSVs (not shown in FIG. 2). Upon application of a differential voltage between the first plate 1300 and the second plate 2300, the two plates will be drawn together, until the shunt bar 1100 with treated surface touches the contacts with treated surfaces 2112 and 2122. Because the surface treatment has smoothed the rougher asperities on the surfaces, the switch can be closed without damage, even though a voltage may exist between the contacts.

Accordingly, a MEMS device is described, which may include at least one first contact surface in the MEMS device, wherein the at least one first contact surface has a surface roughness of less than about 10 nm rms, and at least one additional contact surface, wherein the first and the additional contact surface are configured to be in physical and electrical contact during at least a portion of the MEMS device operation.

Other features may be combined with the concepts disclosed here. For example, the MEMS device may be at least one of a sensor, a switch and an actuator. The contact surface may comprise at least one of gold, Ru, Pd, RuO2, silver, tin and nickel. The MEMS device may be a hot switch that closes two contact surfaces with a voltage differential between the two surfaces. The MEMS device may further comprise a device substrate and a lid substrate, wherein a device cavity is formed in the lid substrate and encloses the device when the lid substrate and device substrate are bonded together. The MEMS device may alternatively be a MEMS switch formed with two substrates, with at least one contact surface on each substrate, wherein the switch is formed when the two substrates are bonded together, and may be electrostatically actuated. The MEMS switch may have a shunt bar on one substrate spanning two contact surfaces on the other substrate, thereby closing the switch. The contact surface may be a conductive pad, wherein the contact surface has an rms roughness of less than about 10 nm, and the contact pad has a thickness of at least about 100 nm. The contact surface may be a contact pad comprising at least one of gold (Au), RuO₂, a gold/nickel alloy, palladium (Pd), silver (Ag) and platinum (Pt).

The method may include treating at least one contact surface by directing ions from an ion mill against the at least one contact surface, and imparting a less than 10 nm rms surface roughness to the at least one contact surface using the ions from the ion mill against the at least one contact surface. Using the ion mill may comprise applying an ion beam at grazing incidence of between about 20 to about 70 degrees to the at least one contact surface, to reduce the roughness on the at least one contact surface to less than about 10 nm rms. The contact surface may had a roughness lower limit about 1 nm.

The device may be at least one of a MEMS switch, a sensor and an actuator using the contact surface. The method may include forming at least one through substrate via that provides external electrical access to the contact surface. The method may also include forming the MEMS device and the contact surface on a device substrate, forming a device cavity in a lid wafer, and enclosing the device and the contact surface in the device cavity by bonding the lid substrate to the device substrate.

In some embodiments, the method may include forming a deformable plate on one substrate and at least on via on a second substrate, forming the switch by bonding the first substrate to the second substrate. In this embodiment, the MEMS switch may be electrostatically actuated. The switch may include a shunt bar on one substrate spans two contact surfaces on the other substrate, thereby closing the switch. The method may include treating of the contact surface comprises removing asperities on the contact surface of a contact pad, until the contact surface has an rms roughness of less than about 10 nm, and the contact pad has a thickness of at least about 100 nm. The treated contact surface may comprise at least one of gold (Au), RuO₂, a gold/nickel alloy, palladium (Pd), silver (Ag) and platinum (Pt).

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. For example, while the disclosure describes a number of fabrication steps and exemplary thicknesses for the layers included in the MEMS switch, it should be understood that these details are exemplary only, and that the systems and methods disclosed here may be applied to any number of alternative MEMS or non-MEMS devices. Furthermore, although the embodiment described herein pertains primarily to an electrical switch, it should be understood that various other devices may be used with the systems and methods described herein, including actuators and valves, for example. Accordingly, the exemplary implementations set forth above, are intended to be illustrative, not limiting.

What is claimed is:

1. A method of making a MEMS device with a first contact surface, comprising:
treating the first contact surface by directing ions from an ion mill against the at least one contact surface; and
imparting a less than 10 nm rms surface roughness to the first contact surface using ions from the ion mill against the at least one contact surface.

2. The method of claim 1, wherein using the ion mill comprises applying to the first contact surface, an ion beam at grazing incidence of between about 20 to about 70 degrees with respect to the first contact surface, to reduce the roughness on the first contact surface to less than about 10 nm rms.

3. The method of claim 2, further comprising:
fabricating at least one of a MEMS switch, a sensor and an actuator using the first contact surface.

4. The method of claim 1, further comprising:
forming at least one through substrate via that provides external electrical access to the first contact surface.

5. The method of claim 3, further comprising:
treating a second contact surface by directing ions from an ion mill against the second contact surface at an acute angle;
imparting a less than 10 nm rms surface roughness to the second contact surface using the ions from the ion mill against the surface; and
disposing the second contact surface adjacent to the first contact surface to form a MEMS hot switch.

6. The method of claim 5, wherein fabricating the MEMS switch comprises:
forming a deformable plate on one substrate;
forming the first and the second contact surfaces on a second substrate;
forming the MEMS switch by bonding the first substrate to the second substrate.

7. The method of claim 6, wherein the MEMS switch is electrostatically actuated by applying a voltage between the at least one electrical via and the deformable plate.

8. The MEMS device of claim 7, wherein when the MEMS switch is electrostatically actuated, a shunt bar disposed on one substrate is lowered and spans the first and the second contact surfaces, both formed on the second substrate, thereby closing the switch, and wherein both the shunt bar and the contact surfaces have a surface roughness of less than about 10 nm rms.

9. The method of claim 1, wherein the treating of the first contact surface comprises removing asperities on the first contact surface, until the first contact surface has an rms roughness of less than about 10 nm, and the contact pad has a thickness of at least about 100 nm.

10. The method of claim 1, wherein the first contact surface comprises at least one of gold (Au), RuO₂, a gold/nickel alloy, palladium (Pd), silver (Ag), platinum (Pt), Ru, tin and nickel.

11. The method of claim 6, wherein the first and the second contact surfaces are configured to be in physical and electrical contact during at least a portion of the MEMS switch operation.

12. The method of claim 6, wherein the MEMS switch is a hot switch, wherein the hot switch closes by electrically connecting the first to the second contact surface with a voltage differential between the first and the second contact surfaces at the instant of switch closure.

13. The method of claim 6, wherein both the first contact surface and the second contact surface have a surface roughness of less than about 10 nm rms.

14. The method of claim 6, wherein the MEMS device further comprises a MEMS switch formed with two substrates, with the first contact surface formed on one substrate and the second contact surface formed on the second substrate, wherein the switch is formed when the one and the second substrates are bonded together.

15. The method of claim 6, wherein when the MEMS switch is electrostatically actuated, a shunt bar on one substrate spans two contact surfaces on the other substrate, thereby closing the switch, and where both the shunt bar and the contact surfaces have a surface roughness of less than about 10 nm rms.

16. The method of claim 6, wherein the first contact surface is the surface of a conductive pad covering a through substrate via, wherein the contact pad has an rms roughness of less than about 10 nm rms, and the contact pad has a thickness of at least about 100 nm.

17. The method of claim 14, wherein the two substrates are bonded together with a hermetic seal.

18. The method of claim 17, wherein the two substrates are bonded together with at least one of thermocompression bond, a metal alloy bond, or a glass frit bond to form the hermetic seal.

19. The method of claim 18, wherein the metal alloy is a gold/indium alloy bond.

20. The method of claim 1, wherein the ions are at least one of Ar+ or Kr+ ions from an Ar+ or Kr+ ion beam.
